(19) United States
(12) Patent Application Publication
(10) Pub. No.: US 2008/0145821 A1
(43) Pub. Date: Jun. 19, 2008

(54) Washable coloring object

(76) Inventor: Hsiu-Chun Chen, Lujhou City (TW)

Correspondence Address: Troxell Law Office Pllc, Suite 1404, 5205 Leesburg Pike, Falls Church, VA, 22041, US

(21) Appl. No.: 11/600,902

(22) Filed: Nov. 17, 2006

(51) Int. Cl. G09B 11/10

(52) U.S. Cl. 434/84

(57) ABSTRACT

The present invention provides a washable coloring object, in which a coloring object is made up of covering layers and packing. A surface of the covering layers is provided with any printed pattern lines and space to enable coloring thereof, and the packing is waterproof and non-water absorbent material. When coloring the coloring object, because the covering layers are washable waterproof material, thus, coloring agents on the coloring object can be easily rinsed away within a few seconds using general clear water or tap water, thereby achieving effectiveness of reusability, environmental protection and safety.

### BACKGROUND OF THE INVENTION

(a) Field of the Invention

The present invention relates to a washable coloring object, wherein a coloring object is provided with covering layers and packing. The covering layers are washable waterproof material, and the packing is a waterproof and non-water absorbent material.

(b) Description of the Prior Art

A conventional coloring object, as depicted in FIG. 1, is made up from sheets of paper A1 and a coloring pen A2. However, the sheets of paper A1 only function to enable color to be added thereto, and lack functionality to easily remove coloring agents within a few seconds using a simple rinsing method with general clear water and tap water to achieve reusable functionality. Hence, such a design causes anxiety in the user because of increased purchasing cost.

Hence, the inventor of the present invention proposes to resolve and surmount existent technical difficulties to eliminate the aforementioned shortcomings of prior art.

### SUMMARY OF THE INVENTION

Art of the present invention provides a washable coloring object, wherein a coloring object comprises covering layers and packing. The covering layers are washable waterproof material, and the packing is waterproof and non-water absorbent material. When coloring the coloring object, because the covering layer are washable waterproof material, thus, coloring agents on the coloring object can be easily washed away within a few seconds using general clear water or tap water without the need for any cleaning agent, thereby achieving effectiveness of reusability, environmental protection and safety.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows an elevational view of prior art.

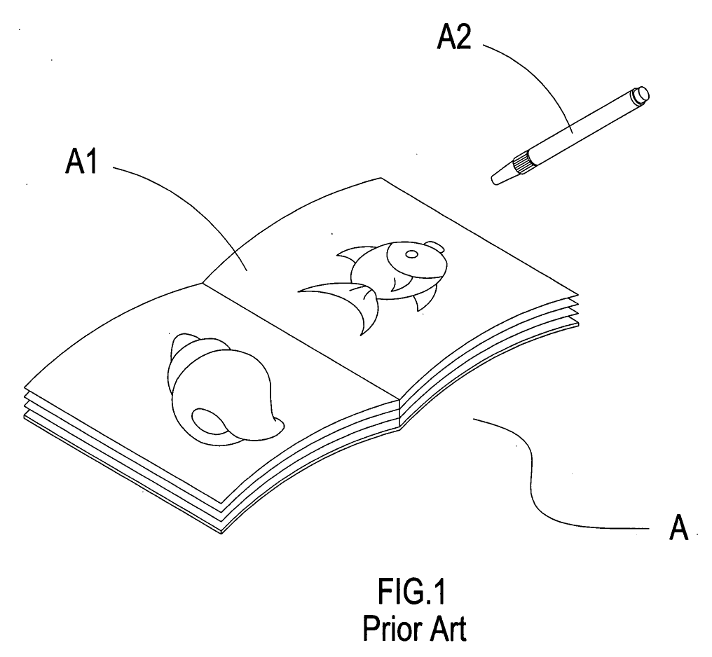

FIG. 2 shows an elevational view according to the present invention.

FIG. 3 shows an exploded elevational view according to the present invention.

FIG. 4 shows a first view of an embodiment according to the present invention.

FIG. 5 shows a second view of an embodiment according to the present invention.

FIG. 6 shows a third view of an embodiment according to the present invention.

FIG. 7 shows a fourth view of an embodiment according to the present invention.

FIG. 8 shows a fifth view of an embodiment according to the present invention.

FIG. 9 shows a sixth view of an embodiment according to the present invention.

FIG. 10 shows a seventh view of an embodiment according to the present invention.

FIG. 11 shows an eighth view of an embodiment according to the present invention.

FIG. 12 shows a ninth view of an embodiment according to the present invention.

FIG. 13 shows a tenth view of an embodiment according to the present invention.

FIG. 14 shows an eleventh view of an embodiment according to the present invention.

### DETAILED DESCRIPTION OF THE PREFERRED EMBODIMENTS

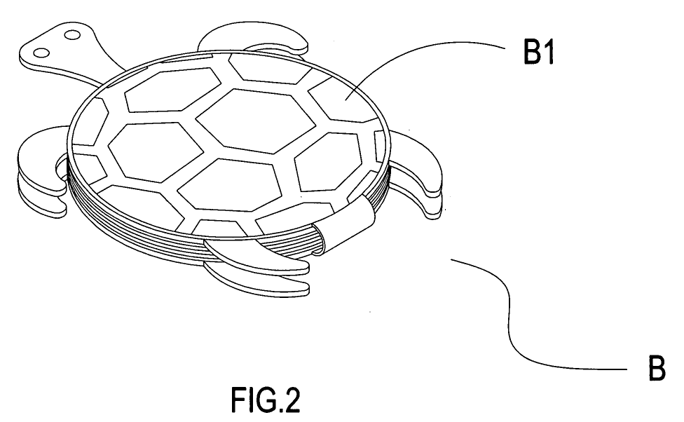

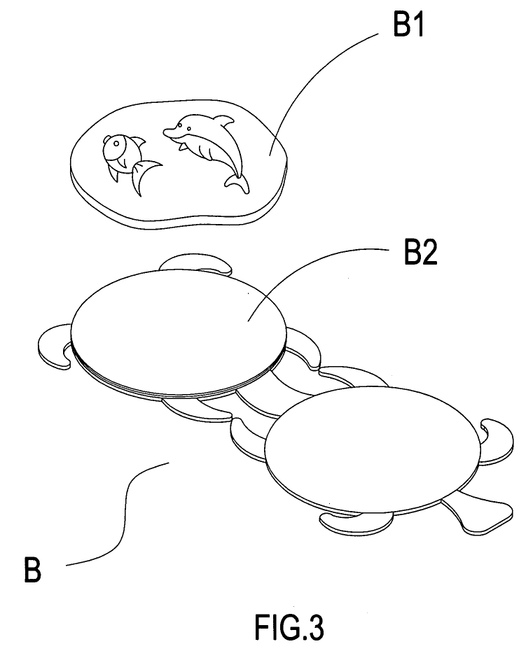

Referring to FIGS. 2 and 3, which show a washable coloring object of the present invention, wherein a coloring object B comprises covering layers B1 and waterproof and non-water absorbent packing B2.

A surface of the covering layers B1 is provided with any printed pattern lines and space to enable coloring thereof. The covering layers B1 are washable waterproof material.

The waterproof and non-water absorbent packing B2 is packed within the coloring object B, thereby enabling the coloring object B to achieve a more effective three-dimensional impression, and enable easy rinsing away of coloring, as well as conveniently enabling the user to directly apply color, which can set off outline features of the coloring object B.

When coloring the coloring object B, because the covering layers B1 are washable waterproof material, thus, coloring agents D on the coloring object B can be easily rinsed away within a few seconds using clear water or tap water directly from a water spout H, thereby providing reusable functionality, and further achieving the objectives of benefiting environmental protection, providing educational amusement, enabling parents and children to have fun together, as well as enabling users to enjoy the fun of DIY (Do It Yourself) and learn painting skills and color recognition.

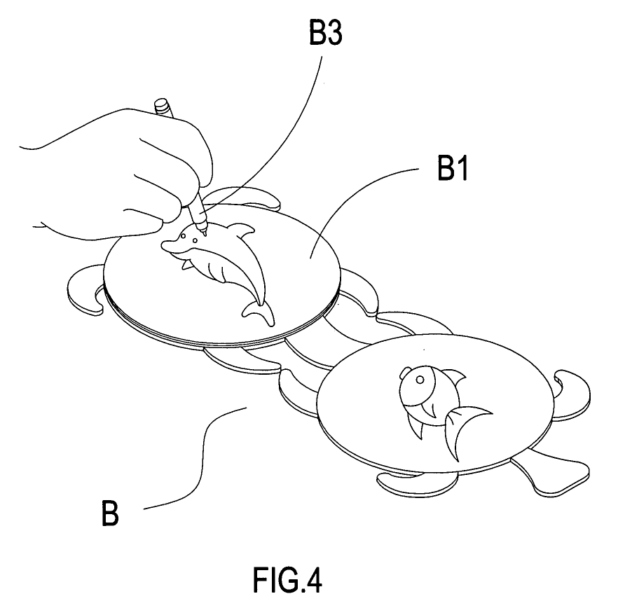

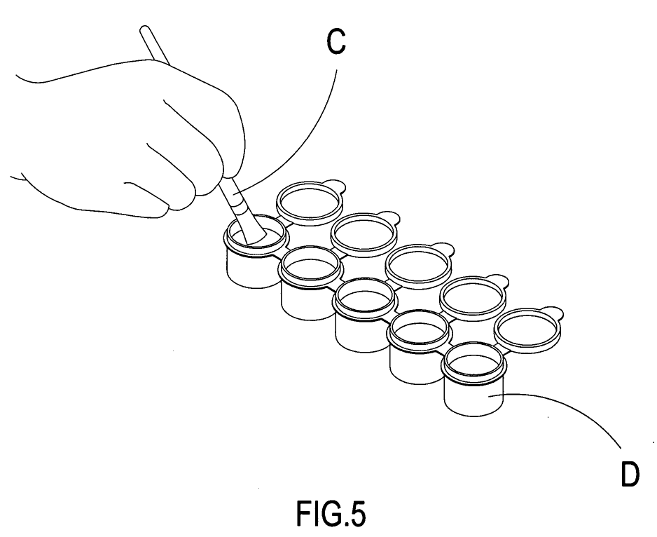

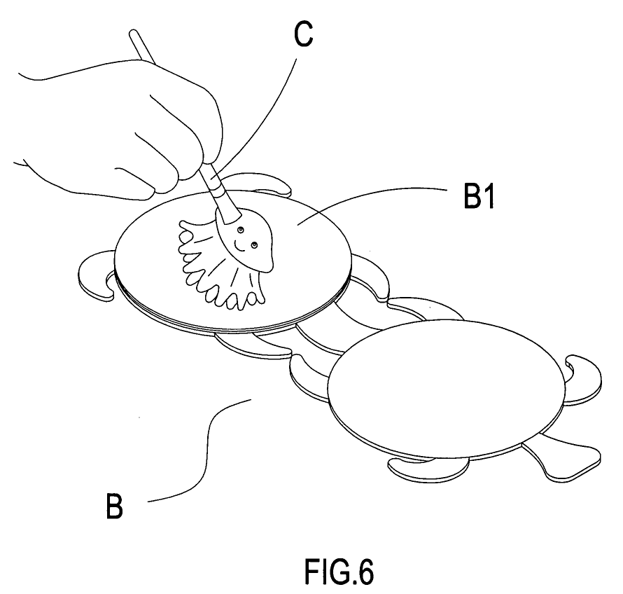

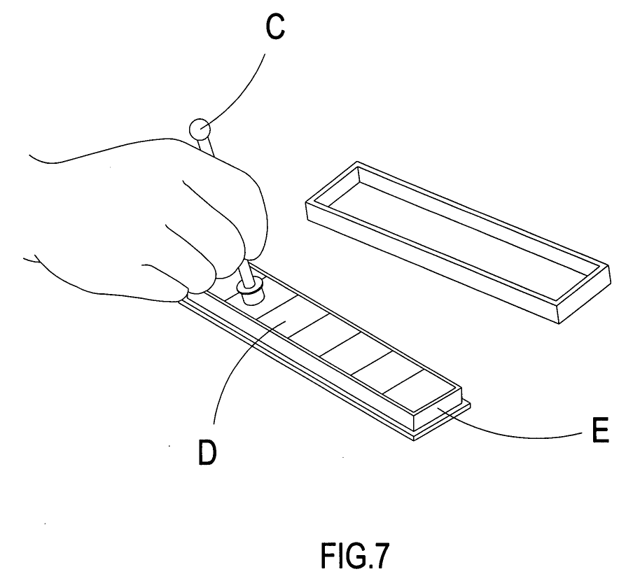

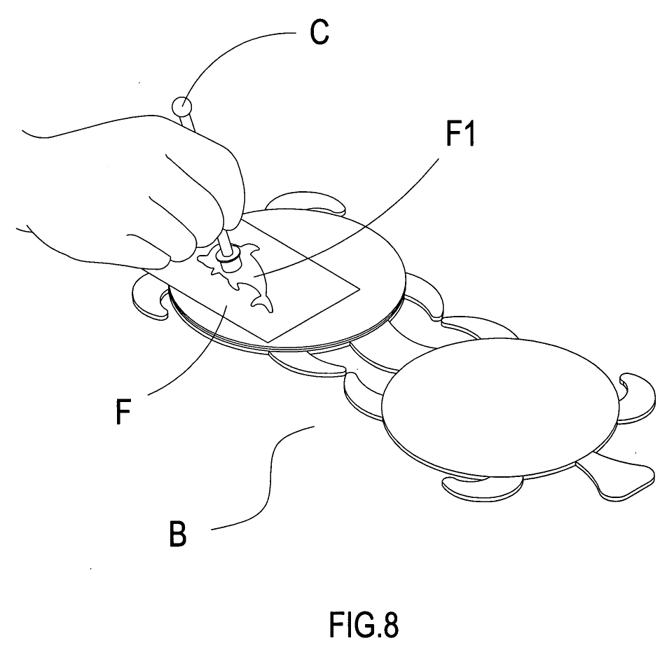

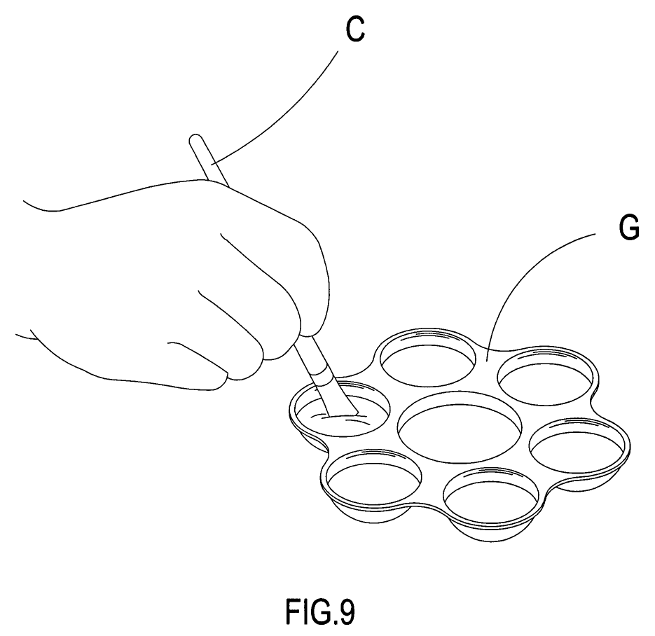

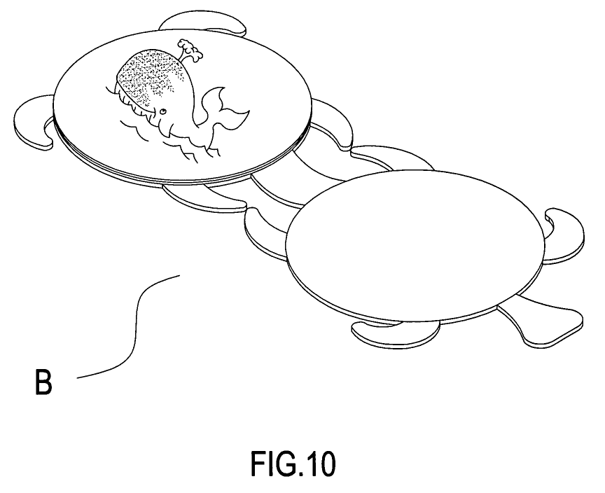

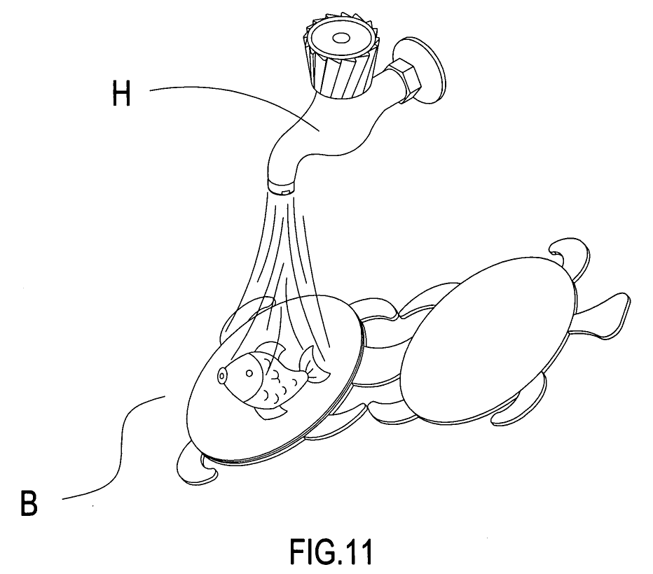

Referring to FIG. 4, FIG. 5, FIG. 6, FIG. 7, FIG. 8, FIG. 9, FIG. 10 and FIG. 11, which show modes of implementation of the washable coloring object of the present invention, wherein the coloring object B comprises the covering layers B1 and the packing B2.

The surface of the covering layers B1 is provided with printed pattern lines and space to enable coloring thereof. The covering layers B1 are washable waterproof material, such as pongee cloth or related material.

The packing B2 is packed within the coloring object B, thereby enabling the coloring object B to achieve a more effective three-dimensional impression, and enable easy rinsing away of coloring, as well as conveniently enabling the user to directly apply color, which can set off outline features of the coloring object B.

When coloring the coloring object B, a coloring pen B3 is used to apply color directly onto the covering layers B1. A coloring pen C can also be dipped with the coloring agent D, which can then be applied to the covering layers B1 of the coloring object B. A rubbing method can also be employed as the coloring method, whereby the coloring agent D is applied to the coloring pen C from a rubbing color box E, and a hollowed out pattern hollow F1 of a rubbing board F is then used to carry out rubbing of color onto a surface of the coloring object B. Moreover, a color mixing tray G can be further employed to mix the coloring agents D for use thereof.

When coloring of the coloring object B is complete, because the covering layers B1 are washable waterproof material, then the coloring agents D on the coloring object B can be easily washed away within a few seconds using clear water or tap water directly from the water spout H without the need for any cleaning agent, thereby providing reusable functionality, and further achieving the objectives of benefiting environmental protection, providing educational amusement, enabling parents and children to have fun together, as well as enabling users to enjoy the fun of DIY (Do It Yourself) and learn painting skills and color recognition.

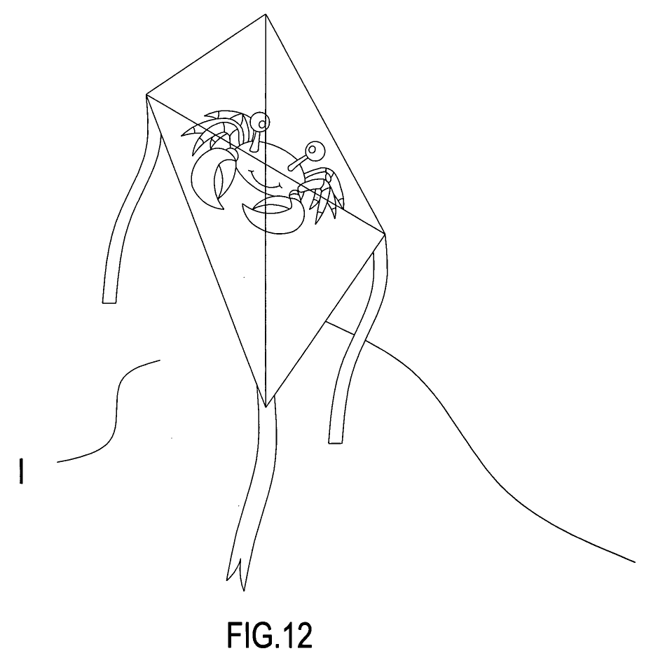

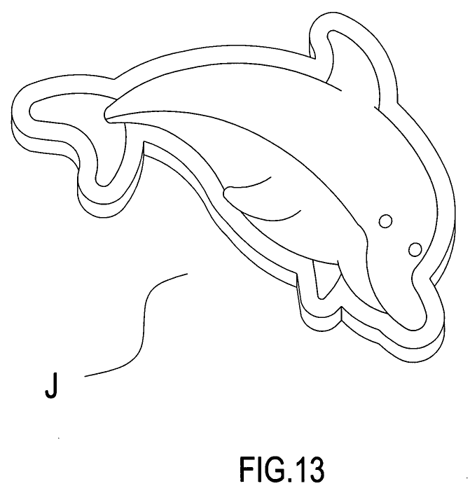

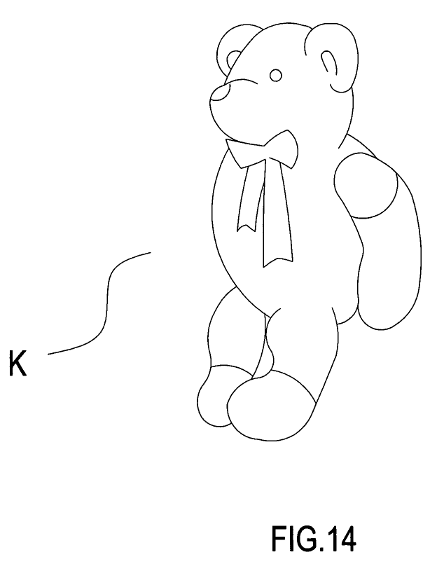

Referring to FIG. 12, FIG. 13 and FIG. 14, wherein the coloring object B can be a single-sided coloring object 1, a double-sided coloring object J and a three-dimensional coloring object K, thereby increasing multiplicity, variability and educational aspect of the coloring function of the present invention, which further enables users to improve their technique in coloring.

In order to better explicitly disclose advancement and practicability of the present invention, a comparison with prior art is described hereinafter:

### Disadvantages of Prior Art

1. The coloring object only provides function to apply color thereto.

2. Lacks functionality to easily remove coloring agents within a few seconds using a simple rinsing method with general clear water and tap water.

3. Lacks reusable functionality.

4. Causes anxiety in the user because of increased purchasing cost.

### Advantages of the Present Invention

1. The covering layers B1 of the coloring object B are washable waterproof material.

2. The coloring agents D can be easily washed away within a few seconds using clear water or tap water directly from a water spout, thereby providing reusable functionality after air drying.

3. Because of advantage 2, the present invention is provided with effectiveness of environmental protection and safety.

4. The coloring object B can be further configured as a single-sided coloring object, a double-sided coloring object and a three-dimensional coloring object.

5. Because of advantage 4, multiplicity, variability and educational aspect of the coloring function is increased, which further enables enhancing learning of coloring techniques.

6. Rich in educational significance, educational amusement and positive value.

7. Increases operational life.

8. Provided with advancement and practicability

9. Enhances commercial competitiveness.

In conclusion, the present invention in overcoming structural shortcomings of prior art has assuredly achieved effectiveness of anticipated advancement, and, moreover, is easily understood by persons unfamiliar with related art. Furthermore, contents of the present invention have not been publicly disclosed prior to this application, and practicability and advancement of the present invention clearly comply with essential elements as required for a new patent application. Accordingly, a new patent application is proposed herein.

It is of course to be understood that the embodiments described herein are merely illustrative of the principles of the invention and that a wide variety of modifications thereto may be effected by persons skilled

What is claimed is:

1. A washable coloring object, comprising covering layers and packing, wherein a surface of the covering layers is provided with printed pattern lines and space to enable coloring thereof, and the packing is packed within the coloring object; the packing is waterproof and non-water absorbent material; the washable coloring object is the covering layers are washable waterproof material; when coloring the coloring object, because the covering layers are washable waterproof material, thus, coloring agents on the coloring object is easily rinsed away within a few seconds using general clear water or tap water, thereby achieving effectiveness of reusability, environmental protection and safety.

2. The washable coloring object according to claim 1, wherein the covering layers are washable waterproof material, including pongee cloth and related material.

3. The washable coloring object according to claim 1, wherein a rubbing method is used as the coloring method to color the coloring object, in conjunction with a rubbing board and a rubbing color box, thereby enabling a user to learn color techniques, including rubbing halo coloring and color overlapping and different pen strokes.

4. The washable coloring object according to claim 1, wherein wax crayons and related coloring pens having function to apply color are used to color the coloring object.

5. The washable coloring object according to claim 1, wherein a color mixing tray is used to mix the coloring agents used to color the coloring object.

6. The washable coloring object according to claim 1, wherein the coloring object is a single-sided coloring object, a double-sided coloring object and a three-dimensional coloring object. in the art without departing from the spirit and scope of the invention as set forth in the following claims.
